(19) United States
(12) Patent Application Publication
(10) Pub. No.: US 2017/0364597 A1
(43) Pub. Date: Dec. 21, 2017

(54) SYSTEM FOR INTERACTIVE ANALYSIS OF DATA

(71) Applicant: Targeteam Services and IT GmbH, Haigerloh (DE)

(72) Inventor: Antonie SCHMIDT, Munich (DE)

(21) Appl. No.: 15/419,024

(22) Filed: Jan. 30, 2017

(30) Foreign Application Priority Data
Jun. 20, 2016 (DE) 20 2016 103 245.8

(51) Int. Cl. G06F 17/30; H04L 29/08; G06Q 50/12; H04L 29/06; G06Q 30/06

(52) U.S. Cl. CPC G06F 17/30867; H04L 67/42; G06Q 30/0645; G06Q 50/12; H04L 67/06

(57) ABSTRACT

A system for interactive analysis of data is provided, the system having a client means and at least one server with a database assigned to the server, in which the data to be analyzed is stored. The data comprises a number of data sets each comprising location information and a number of further attribute values. The server means is adapted to (1) generate an electronic document, with a map and a number of filter modules embedded in the document. An attribute of the data sets is assigned to each filter module, and the attribute values form a filter criterion, and information of the data sets meeting the filter criterion are embedded in the map. The server means further (2) receives, from the electronic document, an update request, which comprises information on the attribute values of a filter module, and (3) generates an update message depending on the received update request.

### CROSS REFERENCE TO RELATED APPLICATIONS

This application claims priority to German Application No. 20 2016 103 245.8, filed Jun. 20, 2016, the contents of which are incorporated by reference herein.

### TECHNICAL FIELD

The invention relates to a system for interactive analysis of data being stored in a storage means, and to the visualization of the analysis at a client means

### BACKGROUND

Systems for analysis of data, which is stored in a server means, are known from prior art. For example, systems are known according to which data sets are stored in a server means, are transmitted to a client means in processed form, and are being displayed there. In order to be able to subject the data to further analysis, it is, for example, necessary to combine the data according to certain attributes, or to filter it according to certain attribute values.

In order to carry out filtering of the data, it is known to generate at the client means a filter criterion or filter rules, which then are transmitted to the server means in order to filter the data sets there. In order to generate such filter criteria or filter rules, it is known to provide filter generators. Such filter generators, however, are to be operated in a complex manner and require a high degree of technical knowledge, because the filters have to be generated by the user by formulating a mathematical filter expression. In fact, it is known to provide such filter generators with a graphical user surface in order to facilitate the generation of the filter expressions. Hereby, however, it is disadvantageous that during generation of a filter expression comprising several filter criteria, the dependencies of the individual filter criteria with respect to each other are not taken into consideration such that an ad hoc adaptation of a filter criterion under consideration of the potential filter criteria of the other filter results is not possible. In order to obtain a desired filtered result of the data, the user, therefore, has to adapt the filter expression in several steps iteratively, if needed.

### SUMMARY

Therefore, it is an object of the present invention to provide a system for interactive analysis of data, which at least partially avoids the disadvantages known from prior art, and by means of which a simple intuitive and, in particular, time-saving analysis of the data is enabled.

According to one embodiment of the invention this object is solved by a system for interactive analysis of data according to the independent claim. Preferred embodiments of the system according to the invention are defined in the dependent claims.

Accordingly, a system for interactive analysis of data is provided, comprising a client means and at least one server means, wherein
the client means is coupled to the at least one server means via a communications network, and wherein at least one data base is assigned to the at least one server means, in which the data to be analyzed is stored,
the data comprise the number of data sets, wherein each data set comprises location information and a number of further attribute values, and
the server means is adapted to
   generate an electronic document and to transmit it to the client means, wherein a map, in particular, a topographic map and a number of filter modules are embedded in the electronic document to be transmitted, wherein
      an attribute of the data sets is assigned to each filter module, and the attribute values of all filter modules together form a filter criterion according to which the data sets are filtered,
      information of those data sets are embedded in the topographic map, which meet the filter criterion, wherein the position of the embedded information on the topographic map correspond to the respective location information of the data set, and
   to receive, from the electronic document transmitted to the client means, an update request comprising information on attribute values of at least one filter module, and depending on the received update request, to generate an update message and transmit it to the client means, wherein the update message comprises information and/or instructions by means of which the client means updates the embedded information and/or the filter modules in the topographic map.

Hereby, it is advantageous that each filter module provides data, which is a component of the entire filter criterion. After transmitting the information on the attribute value or attribute values of a filter module to the server means, the server means is able to evaluate this information and, for example, to transmit filtered data sets to the client means by means of the update message such that, for example, all other filter modules may be adapted. Thus, the user is able to see at one glance, how the other filter modules are modified, if the attribute values of a filter module are filtered or are modified. Thereby, by adapting the individual filter modules, a user may generate a complete filter criterion without having to adapt the filter criterion in several steps iteratively.

It is advantageous, if the information embedded in the topographic map is embedded in the topographic map in accumulated/copied form.

Further, it is preferable, if each filter module visualizes the attribute values of the attribute assigned to the filter module in form of a diagram. Thereby, a more simple and intuitive adaptation of the filter modules, and thereby an intuitive filtering of the data may be realized.

The attribute values may be visualized in the filter module in an accumulated form and/or in a grouped form.

It is specifically advantageous, if the attribute values of those data sets may be visualized in the filter module, which meet the filter criterion. Thereby, only such attribute values in the filter modules are being displayed in an advantageous manner, by means of which a further filtering or limitation of the filter result is achieved. Such attribute values, which do not lead to any further limitation of the filter result, are not being displayed or are made inactive. This has the advantage that the server means is prevented from carrying out further filtering, which does not lead to any modification of the filtered result. In particular with respect to large data amounts, such unnecessary filter steps may lead to substantial speed losses of the server system which are notable for the user, or to a negative response behavior of the server system.

A control element may be assigned to the filter modules respectively, by means of which a user may filter the attribute values of the attribute assigned to the filter module, wherein the filtered attribute values of the respective filter module are a component of the filter criterion, and wherein the filter module is adapted to transmit information on the filtered attribute values to the server means.

The information on the filtered attribute values may be transmitted together with the update message to the server means.

It is preferable, if after filtering of the attribute values assigned to a filter module, the other filter modules are updated automatically, preferably in real-time. Thereby, the user may see at one glance, how a modification of a filter module modifies the other filter modules.

Hereby, it is preferable, if during updating the other filter modules, the attribute values assigned to the respective filter module are selected according to the filter criterion, which is derived from the filtered attribute values. That means that in each filter module, only such attribute values are displayed, the data sets of which meet the complete filter criterion. According to a preferred embodiment of the invention, the server means may further be adapted to embed at least one expert module into the electronic document, wherein the expert module is adapted to visualize two attributes of the data sets in a diagram, preferably on to axes. Thereby, the dependencies of the data sets with respect to attributes may be acquired immediately.

It is preferable, if a control element is assigned to the expert module, which in turn is assigned to either one of the two attributes, wherein a user may filter the attribute values of the respective attribute by means of the control element.

A data table may be assigned to the expert module, which, if needed, may be displayed in the electronic document, wherein data on which the diagram is based may be displayed in the data table.

A data table may be assigned to the expert module, which, if needed, may be displayed in the electronic document, wherein the data on which the diagram is based are being displayed in the data table.

The server means may further be adapted to store the filter criterion together with the data derived therefrom or the filtered data as historical data in the data base.

Further, the server means may further be adapted to compare the data derived after application of a filter criterion to the historical data stored in the data base, and to transmit the result of the comparison to the client means, and to display it there.

It is preferable, if a number of filter criteria is storable in the data base, and if the server means further is adapted to select one of the filter criteria from the data base to apply the selected filter criterion to the data sets, and to transmit the result therefrom to the client means by means of the electronic document.

Thereby, the market development for real estate objects may be monitored in an advantageous manner, if information on properties is stored with the data.

It is preferable, if the location information comprises geo-coordinates, and if the attribute values further assigned to the location information comprise information on a property.

The attribute, which is assigned to a filter module, may be selected from the group comprising the location of the property, the rent of the property, additional costs of the property, rental area of the property, area calculation type for the property, equipment features of the property, year of construction of the property, accessibility of the property to public transportation, accessibility to restaurants, accessibility to hotels, and combinations thereof.

### BRIEF DESCRIPTION OF THE DRAWINGS

Further details and features of the invention as well as concrete technical embodiments and advantages of the invention can be derived from the following description in connection with the drawing, in which:

FIG. 1 is a block diagram of a system according to the invention;

FIG. 2 is an exemplary application of a system according to the invention;

FIG. 3 is an alternative exemplary application of the system according to the invention; and

FIG. 4A-B are examples for a competitor analysis and a competitor matrix respectively as an application for the system according to the invention.

### DETAILED DESCRIPTION

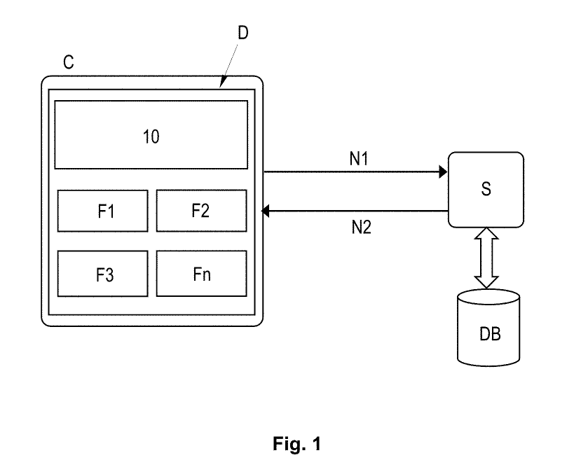

FIG. 1 shows a block diagram of a system for interactive analysis of data according to the invention.

The system comprises a server means S and a client means C, wherein the server means is coupled to the client means via a communications network. Further, the system comprises a data base DB, which is coupled to the server means S, and in which the data to be analyzed is stored.

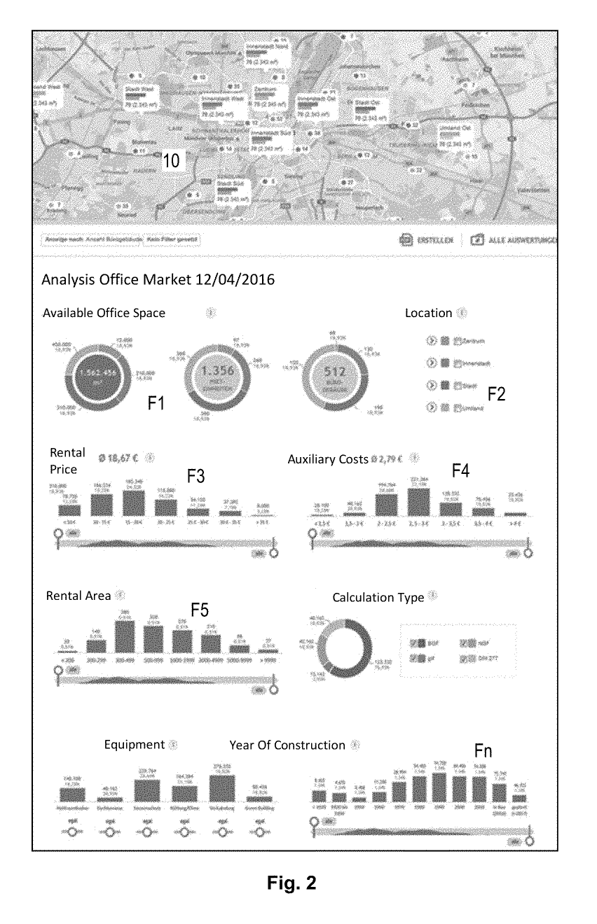

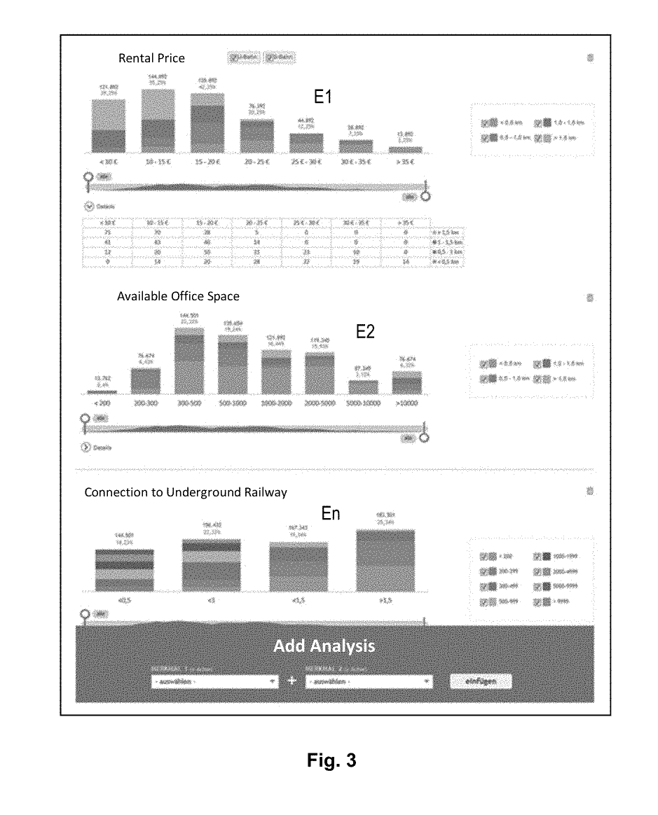

In this example and in the embodiments described in the following FIG. 2 and FIG. 3, it is assumed that the data to be analyzed is data of the real estate market. This data comprises a number of data sets, which respectively comprise location information and further data describing a property. The further data describing a property may be, for example, the rent for the property, the additional costs for the property, the rental area of the property, area calculation type for the property, equipment features of the property, year of construction of the property, and the like.

For landlords or real estate agents of office properties, an efficient and systematic investigation of the office market is of interest, wherein specifically an actual state analysis is of interest. For example, an analysis has to be carried out in order be able to determine the rent, the currently available rental areas, or the year of construction of the office properties in a geographical area. More comprehensive analysis, as, for example, the dependency of the rent with respect to the rental area may also be carried out by the system according to the invention, so as to name only some examples of possible analysis.

In order to be able to carry out such an analysis, the server means S generates an electronic document D, in which a topographic map 10 and a number of filter modules F1 to Fn are embedded. If, for example, an analysis is to be carried out for the wider area of Munich, those data sets are filtered from the data base, which correspond to the location information of the wider area of Munich.

From these filtered data sets for the wider area of Munich, now the characteristics or attribute values are determined for all or for some attributes, and depending on the type of the attribute, a diagram is generated for the respective attribute, which is embedded in the electronic document together with the respective filter module. Hereby, each filter module is assigned to an attribute of the data sets. For example, the attribute “rent” may be assigned to the filter module F3. For the filter module F3, also all values of the attributes “rent” are read from the filtered data sets for the wider area of Munich, and are inserted, for example, in a grouped form as bar diagram into the filter module F3. Thus, for example, certain price ranges can be grouped to one bar of the bar diagram respectively. An example of a filter module F3 for the rent is shown in FIG. 2.

In the topographic map 10, the properties of the wider area of Munich are displayed, wherein the properties are advantageously grouped according to districts, and the accumulated rent area of each group is displayed.

The electronic document thus generated then is transmitted from the server means S to the client means C, and is being displayed there. The user may thus, for example, recognize at one glance, how many rent areas are available in which district, and in which price range the rent is ranging. By means of additional filter modules, the user may recognize further details of the properties for the wider area of Munich at one glance, for example, in which price range the additional costs are ranging, or how the year of construction of the properties is distributed.

Based on this, the user may now carry out a detailed analysis, in which the user may adapt each filter module individually. For this, a control element is assigned to each filter module, by means of which the user may filter or limit the attribute values on which the filter module is based.

For example, a slide control may be assigned to the filter module “rent” F3, by means of which the user may set the minimum and maximum rent. The slide control in the filter module F3, thus, serves as interactive filter. Instead of a slide control, also other input elements may be used, by means of which a minimum or maximum rent may be set. After setting the minimum and maximum rent in the filter module F3, all other filter modules are adapted automatically such that there, now only such attribute values are displayed, the data sets of which meet the filter criterion for the rent. If, for example, a rent between EUR 15 and EUR 25 is set by means of the filter module F3, then, for example, only the additional costs of this property are displayed in the filter module F4, the rent of which lies between EUR 15 and EUR 25. In this manner, all filter modules F1 to Fn depend from each other and are updated automatically as soon as the filter module is modified. The user may analyze the consequences of a modification in a filter module on the other filter modules nearly in real-time.

In the filter module F6, for example, a ring is used as input element for the setting of a filter, wherein the ring comprises several segments. Each segment of the ring represents a filter criterion for the attribute “area calculation type”. Further, each segment of the ring is configured as being “clickable” such that a user, by clicking on a segment, may select an attribute value assigned to this segment as filter criterion. Moreover, it is preferable, if the user may click on several segments such that the correspondingly selected attribute values together form a filter criterion, e.g., filter criterion=“BOF” or “DIN277”.

As soon as a criterion is modified in a filter module, the client means C generates an update request N1 and transmits the latter to the server means S. The server means receives this update request N1, and, depending on the update request, generates an update message N2 and transmits the latter to the client means C. The update message N2, hereby, comprises information and/or instructions by means of which the client means may update the information displayed in the topographic map as well as the other filter modules.

The information and/or instructions comprised in the update message N2 is determined by the server means S by filtering the data sets stored in the data base DB according to the filter criterion transmitted in the update request N1. The thus obtained filtered data may then be transmitted together with the update message N2 to the client means, where the topographic map and the filter modules are then updated accordingly.

If now subsequently the further filter module is adapted, i.e., a further filter criterion is set, also this filter criterion is transmitted to the server means S with the update request N1. The server means S then filters the data sets in the data base DB according to this further filter criterion, wherein also the filter criterion transmitted to the server means previously is taken into consideration. In this manner, all filter modules made available may be adapted or modified, wherein the effects on the other filter modules are visible for the user immediately after each modification of a filter module.

By means of the filter modules, the user may intuitively and in a simple and fast manner, generate a complex filter criterion or a complex filter expression, and hereby, at the same time, may take the dependencies of the filter components with respect to each other into consideration.

A filter criterion thus generated may be stored in the data base DB in order to be able to be reused at a later point of time. Moreover, the result of a filter, i.e., the filtered data meeting the filter criterion, may be stored in the data base as historical data, preferably with a corresponding filter criterion. This enables the user to carry out an analysis with the same filter criterion at a later point of time again, and to compare the result of this analysis to the historical data. Thereby, market development of the properties may be documented.

Further advantages of the system according to the invention, if it is used for the analysis of realty data, are for example:
The offers for office properties for partial markets and districts may be analyzed and evaluated in a fast and simple manner on a daily basis.
Relevant market information may be searched for in a fast and uncomplicated manner.
A complete overview on offers for rent and availabilities for rent areas may be determined.
The market development with respect to certain objects may be documented.
And much more.

FIG. 2 shows an exemplary electronic document, which is generated by the server means S and transmitted to the client means C for the office property market in Munich.

In the topographic map 10, the wider area of Munich is illustrated, wherein accumulated and grouped property data is embedded in the topographic map.

Below the topographic, map, the filter modules F1 to Fn are displayed, which are configured as has been explained previously with reference to FIG. 1 or which provide the functionality as described above.

For example, with respect to the example shown in FIG. 2, the slider control assigned to the filter module F3 may be set such that only those objects are being displayed, the rent of which ranges within a certain price range. After the modification of the slider control assigned to the filter module F3, the topographic map 10 as well as the other filter modules are updated, as has been described previously with respect to FIG. 1. The same applies, if one of the other function modules is adapted.

FIG. 3 shows a further application example of a system for interactive analysis of data according to the invention.

While in FIG. 2, filter modules F1 to Fn are shown, which have been inserted into the electronic document, in FIG. 3, expert modules E1 to En are shown, which also may be inserted into the electronic document. The expert modules, alternatively or in addition to the filter modules, may be inserted into the electronic document. The topographic map 10 is not shown in FIG. 3.

As can be seen in FIG. 3, a diagram is embedded in the expert modules E1 to En respectively, which visualizes two attributes of the data sets on two axes. Thereby, dependencies of two attributes of the data sets with respect to each other may be acquired in a particularly simple manner. Thus, for example, the dependency of the rent with respect to the accessibility to public transportation is visualized in the expert module E1.

Also, a control element, for example, a slider control, may be assigned to the expert modules respectively, by means of which the data sets, on which the diagram of the respective expert module are based, may be filtered.

Below the control elements, as shown with respect to the control element E1, the data on which the respective expert module or the diagram of the respective expert module is based, may be faded in. This data may be displayed, for example, in form of a data table.

Thus, by means of the expert modules, dependencies between two attributes of the data sets may be acquired in a fast and simple manner.

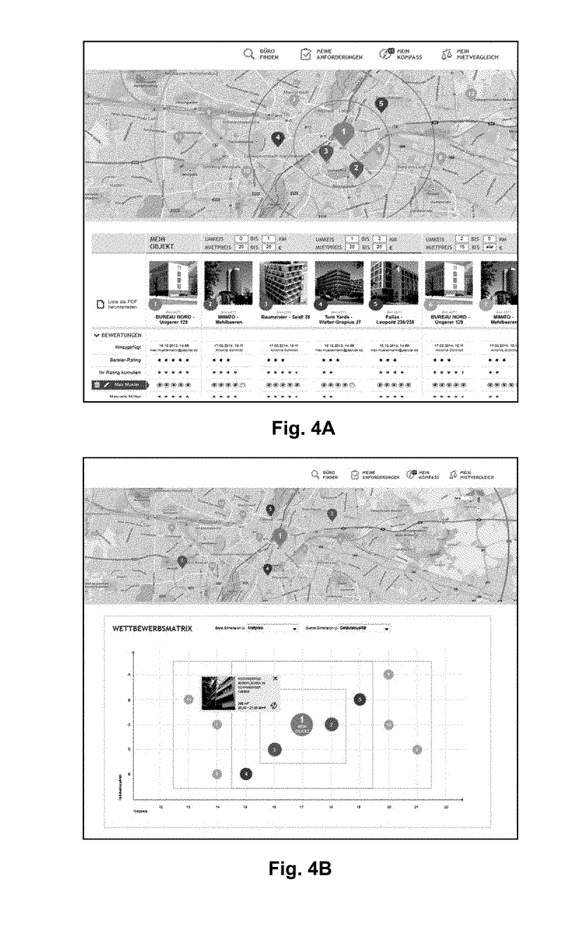

Further, the system according to the invention enables to carry out a so-called competitor analysis, and in particular, in a manner being particularly simple for the user of the system, wherein also the result of the competitor analysis is acquirable for the user in a particularly simple manner. An exemplarily visualization of a competitor analysis and a corresponding competitor matrix are shown in FIGS. 4A and 4B.

For a competitor analysis, a concrete object, for example a property, is contrasted to the current supply market, as the real estate market. The user may select a concrete object, e.g., by selecting on the displayed topographic map or by selecting from a list. Further, the user may set several criteria, which have to be met by the properties of the current supply market, for example, the perimeter around the concrete object and/or a price range for the rent.

Then, all competition objects of the current supply market meeting the filter criteria are displayed to the user, preferably, on the topographic map, as shown in figure (a), and in a list embedded below the topographic map. In the list, which has several lines and columns, each column is assigned to an object. Further, each column is linked to an object in the topographic map such that upon selection of an object in the topographic map, the corresponding column in the list may be highlighted, for example, optically. Thus, the user is able to assign the data for an object in a particularly simple manner to an object on the topographic map.

The columns of the list, moreover, may be sorted according to one or more criteria.

It is preferable, if the result of a competitor analysis is displayed in a so-called competition matrix, as shown in figure (b), and in particular with respect to a concrete object, for which the competitor analysis has been carried out. Thus, for example, the building quality or the year of construction may be contrasted to the rent, wherein the concrete object forms the reference value in the competition matrix. For example, the user is able to recognize in a particularly simple and fast manner, whether there are objects within a certain perimeter to the concrete object, which have a higher building quality, but which nevertheless have a lower rent.

A particular advantage of the system is that during the analysis of the office market data, the single attributes of the data sets may be, on the one hand, illustrated such that they may be recognized by the user in a particularly fast and simple manner. On the other hand, the user may identify the dependencies of the individual attributes particularly fast, because the modification of a filter module immediately affects the data of the other filter modules. These effects on the other filter modules may be discerned by the user also in a particularly simple and fast manner.

### REFERENCE NUMERALS

10 map (topographic map)
C client means
D electronic document
DB data base
E1 to En expert module
F1 to Fn filter modules or filter criteria
N1 update request
N2 update message (result of the request N1)
S server means

What is claimed is:

1. A system for interactive analysis of data having a client means (C) and at least one server means (S), wherein:
the client means is coupled to the at least one server means via a communications network, and wherein a data base (DB) is assigned to the at least one server means, in which the data to be analyzed is stored;
the data comprises a number of data sets, wherein each data set comprises location information and a number of further attribute values, and
the server means is adapted to
generate an electronic document (D) and to transmit it to the client means, wherein a map (10), in particular a topographic map, and a number of filter modules (F1 to Fn) are embedded in the electronic document to be transmitted, wherein
an attribute of the data sets is assigned to each filter module, and the attribute values of all filter modules together form a filter criterion, according to which the data sets are filtered,
information of those data sets are embedded in the map, which meet the filter criterion, and wherein the position of the embedded information corresponds to the respective location information of the data set, and
receive, from the electronic document transmitted to the client means, an update request (N1), which comprises information on the attribute values of at least one filter module, and generate an update message (N2) depending on the received update request, and transmit it to the client means, wherein the update message comprises information and/or instructions, by means of which the client means updates the information embedded in the map or the filter modules.

2. The system of claim 1, wherein the information embedded in the topographic map is embedded in the topographic map in accumulated form.

3. The system of claim 1, wherein each filter module visualizes the attribute values of the attribute assigned to the filter module in the form of a diagram.

4. The system of claim 1, wherein the attribute values are visualized in accumulated form or in grouped form.

5. The system of claim 3, wherein the attribute values of those data sets are visualized which meet the filter criterion.

6. The system of claim 1, wherein a control element is assigned to the filter modules respectively, by means of which a user may filter the attribute values of the attribute assigned to the filter module, wherein the filtered attribute values of the respective filter module is a component of the filter criterion, and wherein the filter module is adapted to transmit information on the filtered attribute values to the server means.

7. The system of claim 6, wherein the information on the filtered attribute values are transmitted to the server means with the update request (N1).

8. The system of claim 6, wherein after filtering of the attribute values assigned to a filter module, the other filter modules are updated automatically, preferably, in real-time.

9. The system of claim 8, wherein during updating of the other filter modules, the attribute values assigned to the respective filter module are selected according to the filter criterion, which is derived from the filtered attribute values.

10. The system of claim 1, wherein the server means is further adapted to embed at least one expert module in the electronic document, wherein the expert module is adapted to visualize two attributes of data sets in a diagram, preferably on two axes.

11. The system of claim 10, wherein a control member is assigned to the expert module, which in turn is assigned to one of the two attributes, wherein a user may filter the attribute values of the respective attribute by means of the control element.

12. The system of claim 10, wherein a data table is assigned to the expert module, which may be displayed in the electronic document, if needed, wherein the data on which the diagram is based is displayed in the data table.

13. The system of claim 11, wherein the server means is further adapted to store the filter criterion together with the data derived therefrom or filtered data as historical data in the data base.

14. The system of claim 13, wherein the server means is further adapted to compare the data derived after application of a filter criterion to the historical data stored in the data base, and to transmit the result of the comparison to the client means.

15. The system of claim 1, wherein a number of filter criteria is storable in the data base, and wherein the server means is further adapted to select one of the filter criteria from the data base, to apply the selected filter criterion to the data sets, and to transmit the result of this to the client means by means of the electronic document.

16. The system of claim 1, wherein the location information comprises geo-coordinates, and wherein the further attribute values assigned to the location information comprise further information on a property.

17. The system of claim 1, wherein the attribute, which is assigned to a filter module, is selected from a group comprising location of the properties, rent of the properties, additional costs of the properties, rental area of the properties, area calculation type, equipment features of the properties, year of construction of the properties, accessibility of the properties to public transportation, accessibility to restaurants, accessibility to hotels, and combinations thereof.
